(19) United States
(12) Patent Application Publication
(10) Pub. No.: US 2023/0303923 A1
(43) Pub. Date: Sep. 28, 2023

(54) TEMPERATURE-SENSITIVE MATERIAL, A METHOD FOR ITS MANUFACTURE, AND A METHOD DETERMINING A THERMAL HISTORY OF THE MATERIAL

(71) Applicant: Sensor Coating Systems Limited, London (GB)

(72) Inventors: Silvia ARAGUAS RODRIGUEZ, London (GB); Jörg FEIST, London (GB); Christopher PILGRIM, London (GB)

(21) Appl. No.: 18/000,954

(22) PCT Filed: Jun. 8, 2021
(86) PCT No.: PCT/GB2021/051421

§ 371 Date: Dec. 7, 2022

(30) Foreign Application Priority Data
Jun. 8, 2020 (GB) 2008621.1

(51) Int. Cl. C09K 11/77; C09D 1/00; C09D 5/22; C09D 5/03; G01K 11/20; C23C 4/11

(52) U.S. Cl. CPC C09K 11/7792; C09D 1/00; C09D 5/22; C09D 5/031; C09D 5/032; C09K 11/77922; C23C 4/11; G01K 11/20

(57) ABSTRACT

The present invention provides a temperature-sensitive material comprising a ceramic oxide host and a luminescent dopant, wherein the material exhibits one or more phase transformations, a powder comprising the material, a method of fabricating the powder, a coating comprising the material, a method of applying the coating, and a method of determining a thermal history of the material which has been subjected to a high temperature environment.

The present invention relates to a temperature-sensitive material, a method for its manufacture, and a method of determining a thermal history of the material, as well as a powder comprising the material, a coating comprising the material applied to a substrate, a method fabricating the powder and a method of applying the coating.

In many industrial applications, it is necessary to measure the operating temperature of critical components. However, due to the nature of their operating environment, conventional temperature measurement methods are practically limited or impossible.

It has been shown that a temperature sensitive coating can be produced by exploiting the amorphous to crystalline transition of a ceramic material. A system and method for producing and measuring such coatings is disclosed in WO-A-2009083729.

According to the principle of the amorphous to crystalline transition covered in WO-A-2009083729, it was expected that once the material is crystalline there would be no further changes in the lifetime decay of the material. The material compositions of this patent are disclosed as operative in temperatures up to the temperature at which the material crystallizes.

It is an aim of the present invention to provide a material for and method of determining thermal history of components which are subjected to high temperature environments.

It is another aim of the present invention to provide luminescent material compositions which are operative in higher-temperature environments, typically ranging from 1000° C. and above, and which can be used to indicate a thermal history or past temperature exposure.

In one aspect, the present invention provides a temperature-sensitive material comprising a ceramic oxide host and a luminescent dopant, wherein the material exhibits one or more phase transformations.

In another aspect the present invention provides a powder comprising the material described.

In another aspect the present invention provides a method of fabricating the powder comprising the material described, wherein the method comprises mixing at least two precursor materials and the dopant to provide a mixture, spray drying the mixture to form precursor particles, and agglomerating or sintering the precursor particles to form a ceramic oxide powder.

In another aspect the present invention provides a coating comprising the material described applied to a substrate.

In another aspect the present invention provides a method applying the coating comprising the material described, wherein the method comprises thermally spraying a powder comprising the material onto the substrate, optionally by plasma spray coating, atmospheric or air plasma spray coating, suspension plasma spray coating, solution precursor plasma spray coating, oxy-fuel spray coating or high-velocity oxy-fuel spray coating.

In another aspect the present invention provides a method of determining a thermal history of the material described, the method comprising (I) obtaining at least one first measurement of luminescence as a function of time from the material; (II) obtaining at least one second measurement of luminescence as a function of wavelength from the material; and (III) determining a temperature to which the material has been subjected by referencing the at least one first measurement and at least one second measurement to calibration data for the material.

The lifetime decay of the material according to the present invention can change even when the material appears to be fully crystalline.

The term ‘phase transformation’ or ‘phase transition’ refers to changes undergone by a substance. Solid-solid phase transitions occur in single component system, where one crystalline solid is transformed into another crystalline solid without entering the liquid state. This is primarily done through changes in temperature or pressure. These transitions result in material polymorphs of the same compound. Different phases (polymorphs) can exhibit different material structure, bond and atomic placement, volume enthalpy, entropy, etc. Phase transformations can occur as a result of one or more of fabrication route, temperature, pressure and time, and so can be encouraged or suppressed depending on these variables.

The material according to the present invention permanently changes its luminescent characteristics when heat treated at temperatures above its crystallisation temperature. This behaviour is used to determine the maximum temperature to which the material or a coating comprising the material was exposed.

The temperature sensitive material of the present invention is in a crystalline state prior to exposure to a thermal environment and at least one luminescence characteristic of the material is a function of the phase transformation of the material and the temperature of the environment to which the material has been exposed.

The present invention accordingly describes a new mechanism whereby a luminescent ceramic material permanently changes at or above its crystallization temperature due to thermal exposure and this can be exploited for temperature measures.

The temperature sensitive coatings are composed of a rare-earth doped ceramic material. When illuminated with light, the rare-earth ions are excited, resulting in the promotion of electrons to a high energy state from the ground state. Following the excitation, the electrons relax back to the ground state through two competitive processes: radiative and non-radiative relaxation. Radiative relaxation causes photon emission, while non-radiative relaxation results in phonon emission. The duration of the emission is governed by the probability of these two processes occurring (Eq. 1):

$$τ = \frac{1}{{P}_{R} + {P}_{N R}} \qquad \text{(1)}$$

Where T is the lifetime decay, P_{R} is the probability of the radiative relaxation and P_{NR} is the probability of non-radiative relaxation.

The probability of radiative relaxation is temperature independent while the probability of non-radiative relaxation is affected by the local atomic environment of the rare-earth ions. For example, the microstructure of the deposited coating can be amorphous. Amorphous structures have an irregular arrangement of atoms and matrix defects, increasing the non-radiative probability. By increasing the heat treatment temperature, and thus the crystallinity of the material, the concentration of luminescence quenchers and the P_{NR} decreases, hence the T increases. As crystallization is a gradual process, so is the change in the luminescent properties.

The lifetime decay (T) can be measured experimentally by recording the emission intensity (I) after pulsed excitation of the material and it approximately follows the following relationship, where I₀ is the initial intensity, T is the lifetime decay and t the time (Eq. 2):

$$I \left(t\right) = {I}_{0} exp \left(\frac{- t}{τ}\right) \qquad \text{(2)}$$

Fitting the observed signal to the equation above, the lifetime decay parameter can be quantified, hence thermally induced changes in the non-radiative probability can be determined.

The luminescence signal can also follow a multi-exponential behaviour because the emission can emanate from different luminescence sources which have different decay times. The different decay signals are observed simultaneously hence overlap and result in a multi-exponential signal. The multi-exponential signal can be deconvoluted to provide more information about the material.

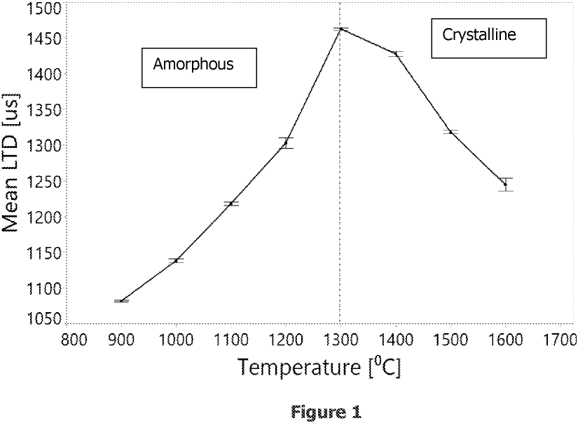

An example, see FIG. 1, shows that the lifetime decay steadily increases to the crystallisation temperature, then gradually decreases after complete crystallisation. Therefore, a new mechanism has been identified that can be exploited for a temperature sensitive coating.

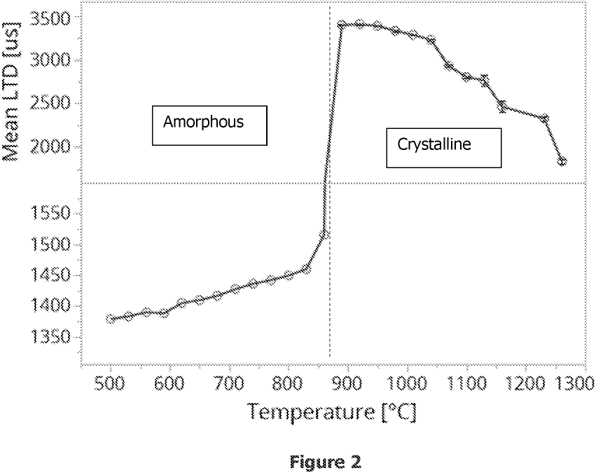

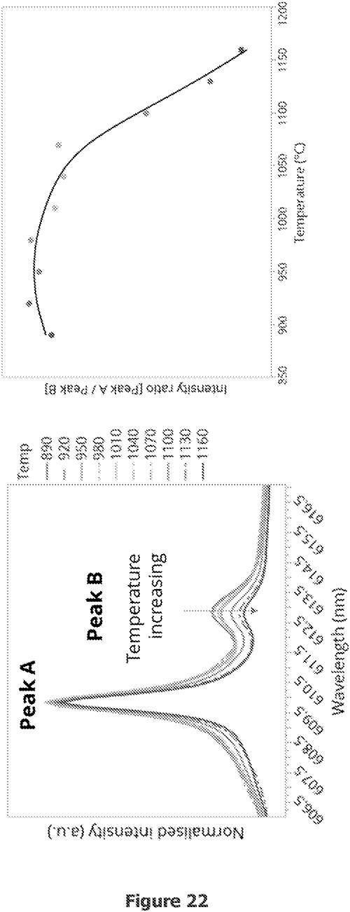

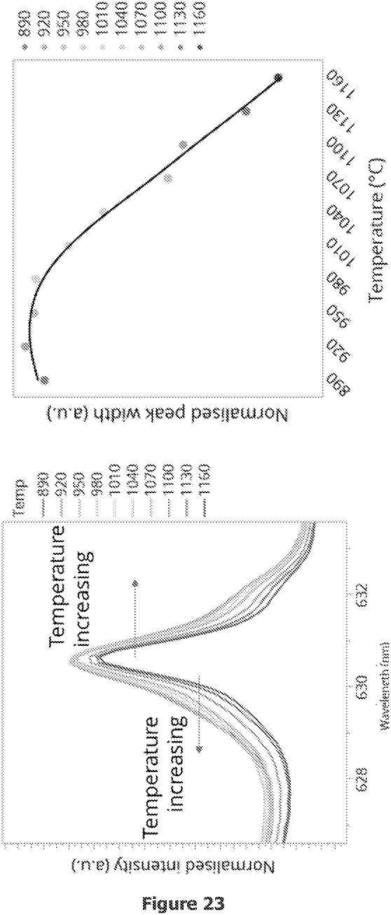

The main steps in producing this mechanism are as follows:
An oxide ceramic material (host) is produced with a small amount of dopant material (dopant) that makes the combined material luminescent. The preferred materials are as follows, however, other oxide ceramics are suitable.
   Hosts: combination of Y₂O₃ and Al₂O₃, combination of Y₂O₃ and SiO₂, Al₂O₃
   Dopants: preferred Eu, other rare earth elements, and transition metals
The combined material is placed into a test environment where temperature measurement
The thermal exposure in the test environment permanently changes the luminescent material
The permanent changes occur above the crystallisation temperature of the material
The changes in the material are detected by measurement of its luminescence properties
The measured luminescence properties can be:
   The lifetime decay of the material after pulsed excitation (FIGS. 1 and 2)
   The intensity ratio of two emission peaks at distinct wavelengths (FIG. 22)
   The shape of the emission peaks at distinct wavelengths (FIG. 23)
   A combination of these approaches
   The measurement parameter is related to temperature through calibration to deliver a temperature measurement for the material in the test environment.
Preferred embodiments of the present invention will now be described hereinbelow by way of example only with reference to the accompanying drawings, in which:

FIG. 1 illustrates a Y₂SiO₅:Eu calibration curve. Note that the lifetime decay increases up to the material’s crystallisation temperature (1300° C.) and then decreases due to other phase transformations;

FIG. 2 illustrates a Y₃Al₅O₁₂ calibration curve. Note that the lifetime decay increases up to the material’s crystallisation temperature (~900° C.) and then decreases due to other phase transformations;

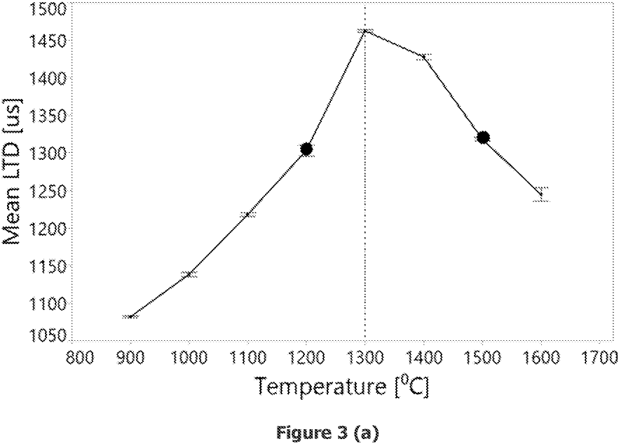

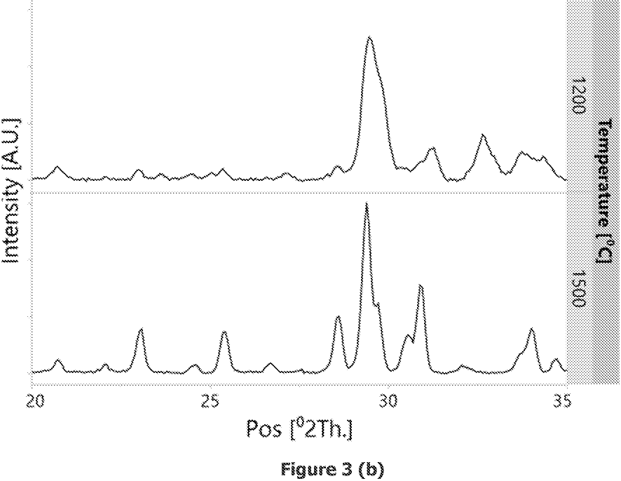

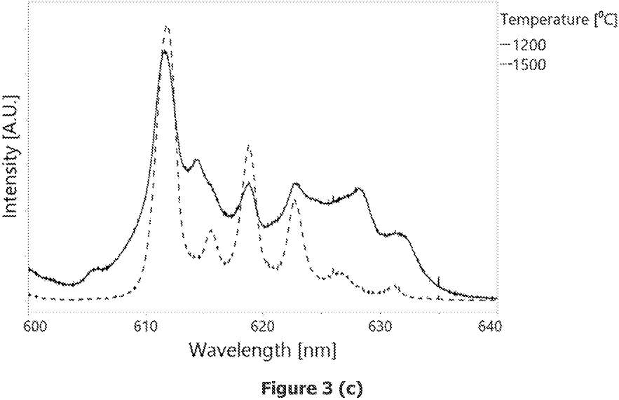

FIG. 3 illustrates (a) a Y₂SiO₅:Eu calibration curve, (b) a Y₂SiO₅:Eu XRD and (c) a Y₂SiO₅:Eu optical spectra. Note that, due to a phase transformation within the material, both the XRD and the optical spectra peaks do change with temperature as well as the calibration curve;

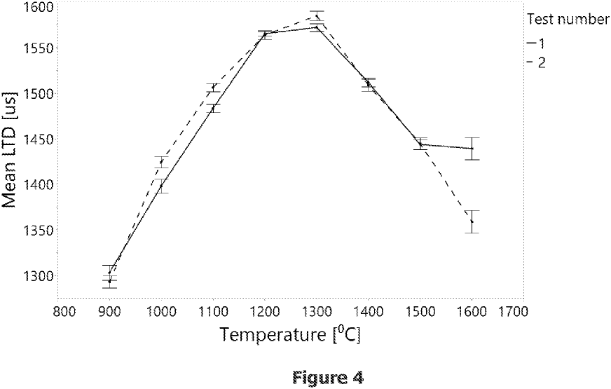

FIG. 4 illustrates two different Y₂SiO₅:Eu calibration curves showing good repeatability results;

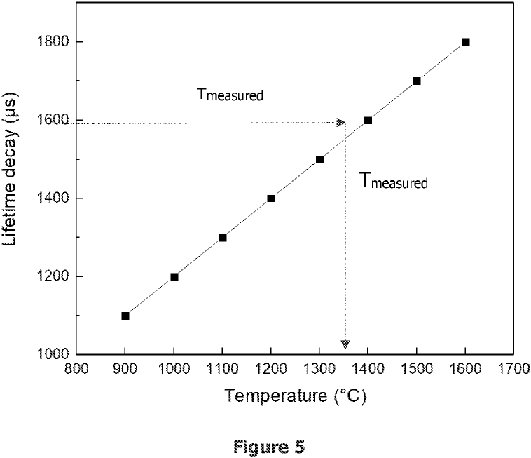

FIG. 5 illustrates an idealised calibration data set, where an example measured lifetime decay value is 1550 µs is translated to a measured temperature of 1350° C.;

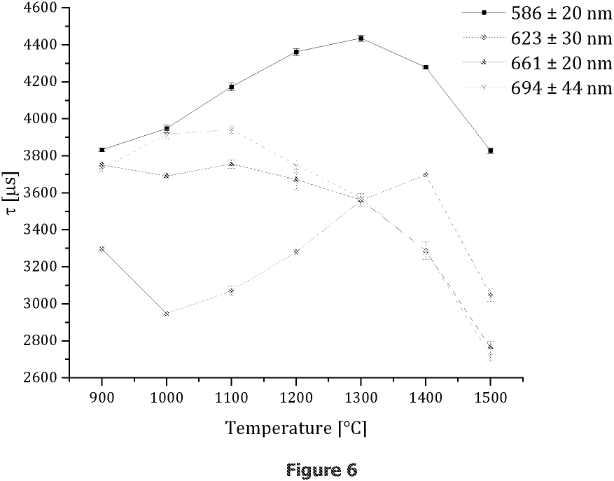

FIG. 6 illustrates changes in lifetime decay with heat treatment temperature for powder samples of YAG doped with Eu;

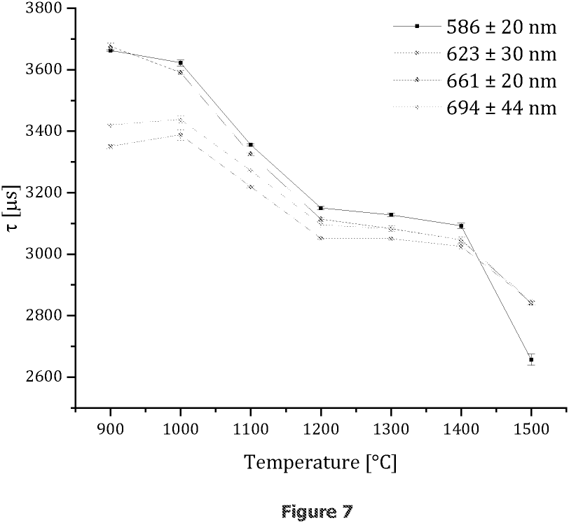

FIG. 7 illustrates changes in lifetime decay with heat treatment temperature for powder samples of YAM doped with Eu;

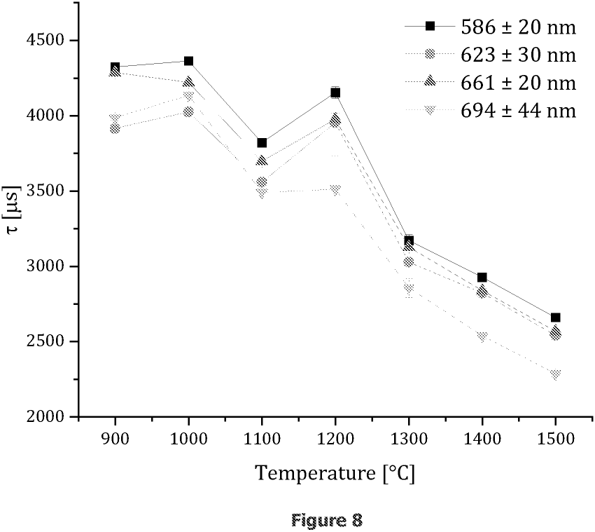

FIG. 8 illustrates changes in lifetime decay with heat treatment temperature for powder samples of YAP doped with Eu;

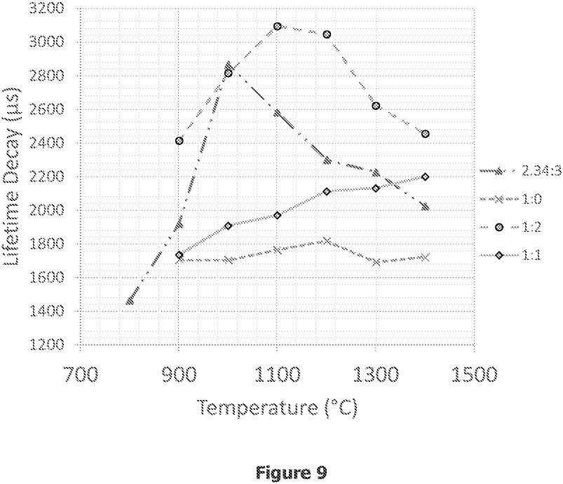

FIG. 9 illustrates changes in lifetime decay with heat treatment temperature for powder samples of various yttrium silicate phases. The legend refers to the ratio of Y₂O₃:SiO₂. Measurements were acquired with emission filter of 625±15 nm. The 1:0 ratio (cross markers) is an example of a material that is not suitable;

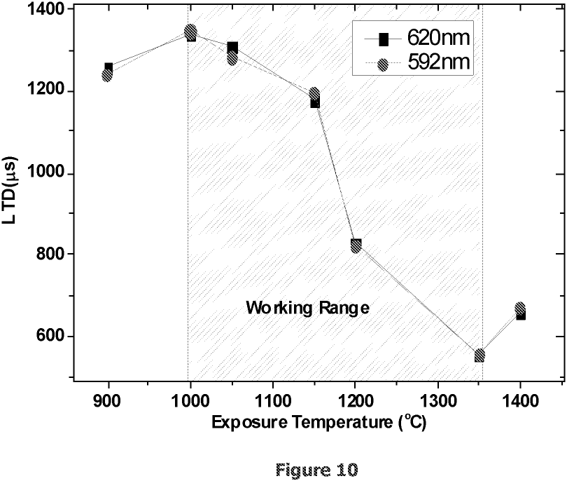

FIG. 10 illustrates change in lifetime decay (LTD) with heat treatment temperature for powder samples of aluminium oxide doped with Eu for two observation wavelengths;

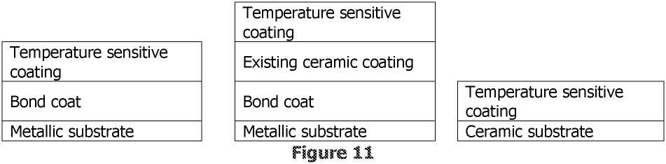

FIG. 11 illustrates schematics of the cross-section of the different possible coating structures;

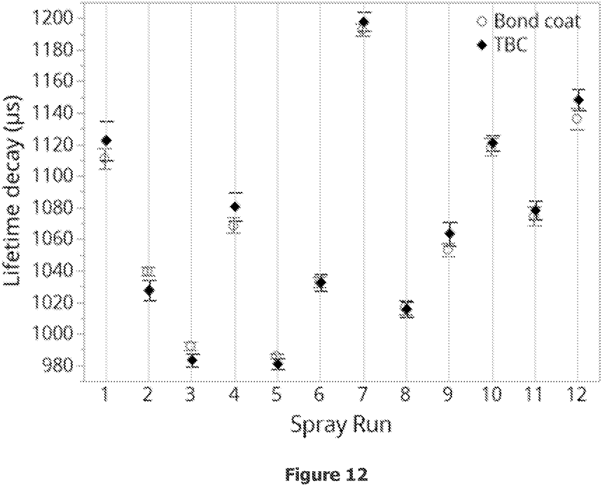

FIG. 12 illustrates the change in lifetime decay of an as-deposited YSO:Eu temperature sensitive coating for 12 different spray system settings. The open markers are samples in which the coating was applied to a bond coat. The closed markers are samples in which the coating was applied to an existing ceramic thermal barrier coating. There was no significant difference in the outcome between the two coating configurations;

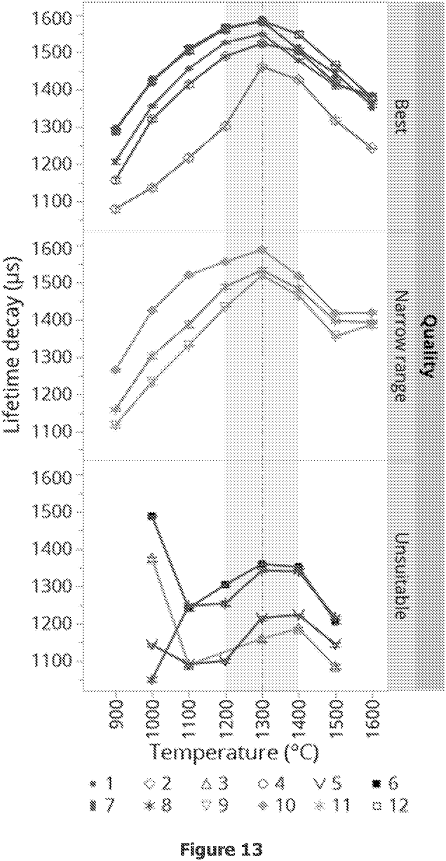

FIG. 13 illustrates the change in lifetime decay with heat treatment temperature of YSO:Eu temperature sensitive coating for 12 different spray system settings;

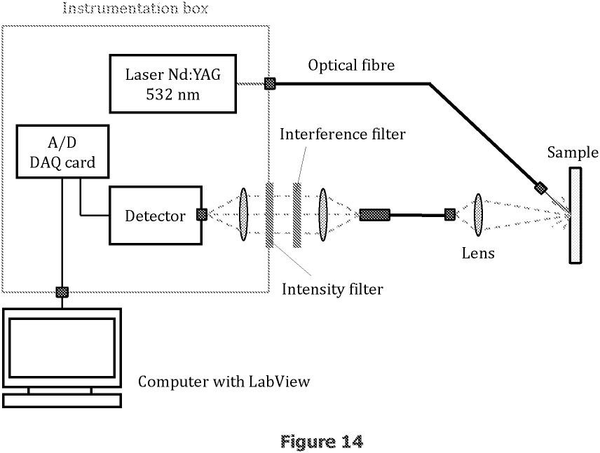

FIG. 14 illustrates an opto-electronic instrument for measuring the lifetime decay of the temperature sensitive coating;

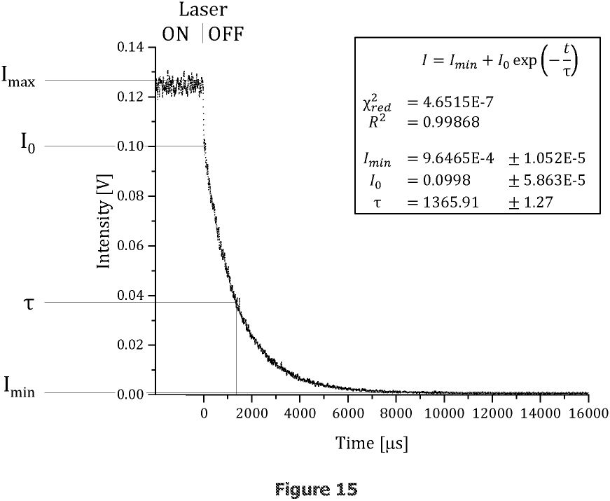

FIG. 15 illustrates an exemplary lifetime decay signal recorded with the opto-electronic instrument;

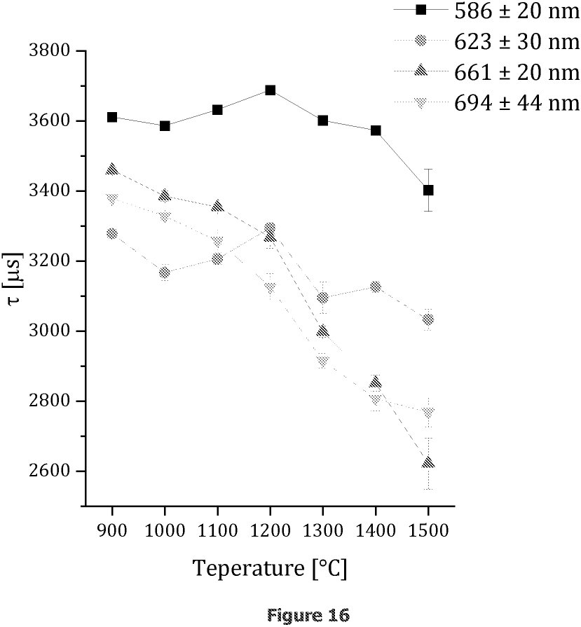

FIG. 16 illustrates the change in lifetime decay with heat treatment temperature for YAG:Eu coating samples when recorded with different interference filters indicated in the legend;

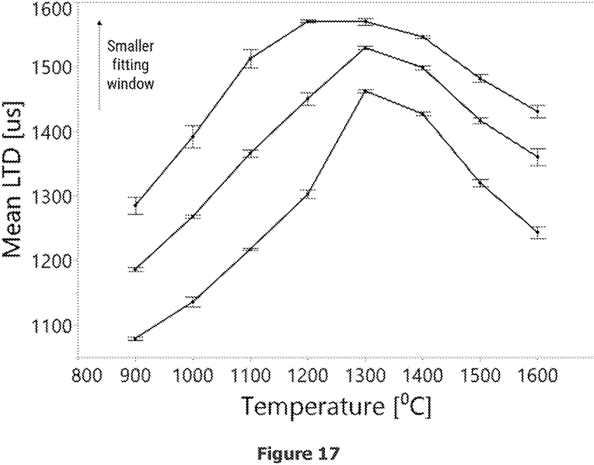

FIG. 17 illustrates same calibration data set with different fitting windows;

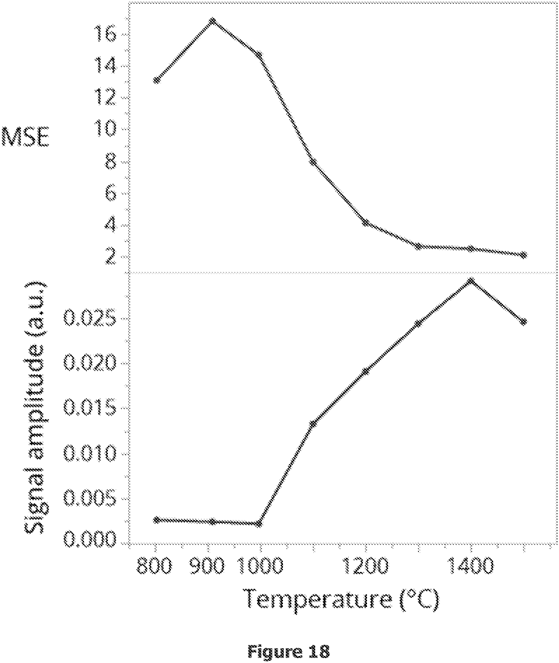

FIG. 18 illustrates changes in measurement parameters aside from lifetime decay, (top) MSE and (bottom) signal amplitude;

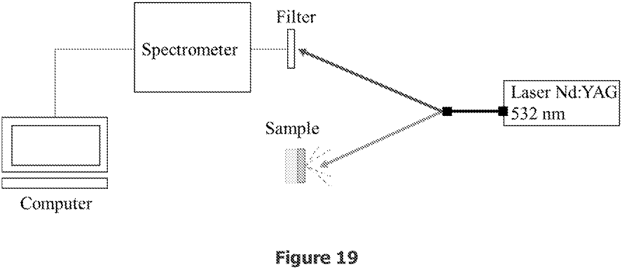

FIG. 19 illustrates schematics of the optical spectrometer used;

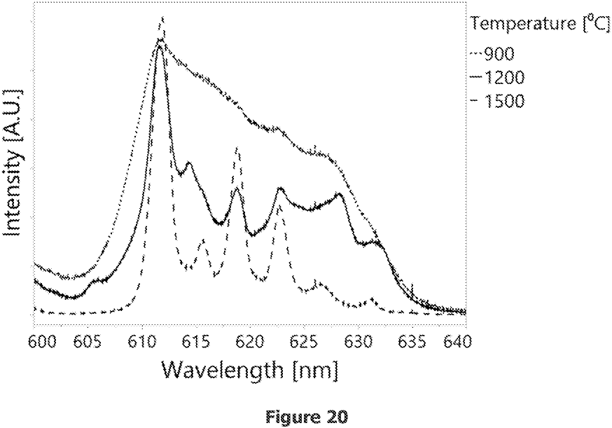

FIG. 20 illustrates Y₂SiO₅:Eu optical spectra showing peak changes with temperature. At 900° C., because the material is amorphous, a broader peak is observed. However, at crystallisation temperatures (1500° C.) narrower peaks are observed;

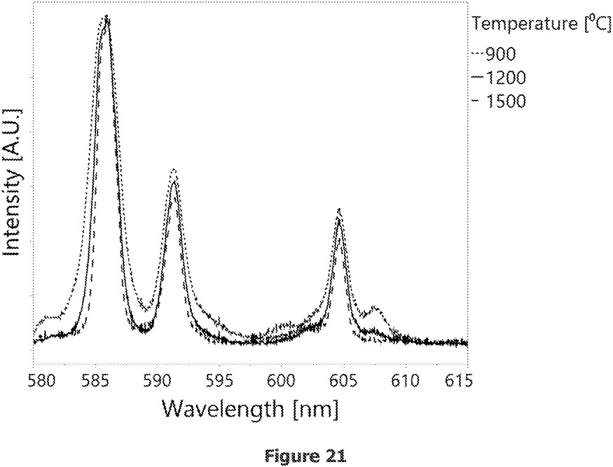

FIG. 21 illustrates YAG’s optical spectra showing peak changes with temperature;

FIG. 22 illustrates sample spectral emission data for YAG coatings (left). The spectral emission of one particular peak can be analysed. The ratio of intensities of Peak A and B as a function of temperature (right);

FIG. 23 illustrates sample spectral emission data for YAG coatings (left). The spectral emission of one particular peak can be analysed. The peak width as a function of temperature (right).

Note: the temperature in all figures corresponds to past/historic temperature of exposure. Measurements were carried out at room-temperature following the heat-treatment at the denoted temperatures.

### DESCRIPTION OF PREFERRED EMBODIMENTS

In one embodiment, an oxide ceramic material is manufactured in powder form. In the manufacture, the material is doped with rare-earth ions to make the material luminescent. The powder is processed and heat treated to form the desired end product. The powder may be used in this form or used as feedstock to a coating process. In either the powder or coating form, the product contains a high amorphous fraction. The powder or coating is then heat treated in the test application conditions. The elevated temperature of operation causes the material microstructure to permanently change. The amorphous content will transform to crystalline and the extent of the transformation depends on the maximum temperature of operation. This transformation causes changes to the luminescence which can be detected and related to the maximum temperature of operation, as described WO-A-2009083729. At or above a certain temperature (crystallisation temperature) the material is completely crystalline. In this temperature range, the material microstructure can change due to phase changes. These changes may only occur in some materials and processing routes due to the complex phase composition of the produced material. These phase changes in the material may be difficult to detect using standard materials characterisation techniques because only a relatively small fraction of the material is affected. However, due to the sensitivity of the rare-earth ions to their local environment, they make a significant difference to the luminescence properties (FIGS. 3). The phase of the host material surrounding the rare-earth ions affects their energy levels and, hence, the luminescence properties. The change in luminescence properties can be observed in the lifetime decay or the emission spectrum of the material (FIGS. 1 and 2). These changes reliably and repeatability occur with different materials such that they can be used to make a temperature sensor (FIG. 4).

To make a temperature sensor, the change in the luminescence properties must be related to temperature. This is done by producing samples of the same temperature sensitive material, then heat treating them under controlled conditions and subsequently measuring their luminescence properties. When repeated for multiple samples over a temperature range, a calibration data set is generated, relating a luminescence property to the heat treatment temperature. An example is shown in FIG. 5, where the luminescence property is the lifetime decay.

A component with temperature sensitive coating tested to an unknown temperature is measured using the same instrument to record the luminescence properties at different locations on the coating. An example is shown with the dashed line in FIG. 5 (T_{measured}). The calibration data set is used to translate the measured luminescence property to a temperature (T_{measured}). Repeating this process at multiple locations, a temperature profile is generated.

### Composition

In one embodiment, the luminescent coating comprises an oxide ceramic host doped with rare-earth ions. The coating is typically formed by the manufacture of the desired material in a powder form which is applied onto the surface by a thermal spray process. Some examples of the composition of the precursor powder are provided below.

### Y-Al-O

In one embodiment of the present invention, the ceramic host is a combination of yttrium oxide (Y₂O₃) and aluminium oxide (Al₂O₃). In this case, the preferred ratio of these two oxides is 2.5:1.5 resulting in Y₃Al₅O₁₂ also known as yttrium aluminium garnet (YAG), see FIG. 6. However, other ratios have shown similar behaviour, for example 1:1 (YAP - FIG. 7) and 2:1 (YAM - FIG. 8).

### Y-Si-O

In another embodiment of the present invention, the ceramic host is a combination of yttrium oxide (Y₂O₃) and silicon oxide (SiO₂). A range of ratios have been shown to exhibit the mechanism of this invention (FIG. 9). The possible range of this ratio is 0.4:0.6 to 0.1:0.9. The preferred range of the ratio of these two oxides is 0.5:0.5 to 0.25:0.75.

### Other Hosts

In principle, other oxide ceramics could be used as hosts, particularly those that incorporate the primary oxides mentioned above (aluminium oxide, yttrium oxide and silicon oxide) but also including zirconium oxide. The possible hosts include any oxides or combinations of: Sc, Y, La, Ti, Zr, Hf, V, Nb, Ta, Cr, Mo, Mn, Zn, Cd, Ce, Pr, Nd, Pm, Sm, Gd, Tb, Dy, Ho, Er, Tm, Yb, Lu.

For example, it has been observed that the lifetime decay of aluminium oxide doped with europium changes above its crystallisation temperature, likely due to phase changes within the material (FIG. 10).

### Dopants

In principle, all rare-earth ions could be used as dopants. The preferred rare-earth dopant is europium in both embodiments mentioned above. The preferred concentration of europium is between 0.01 and 3 at.% and the optimum concentration is between 0.4 and 0.8 at.%. Other possible dopants include: Ce, Pr, Nd, Pm, Sm, Gd, Tb, Dy, Ho, Er, Tm, Yb, Lu.

Transition metals may also be used as dopants including Ti, V, Cr, Mn, Fe, Co, Ni, Cu, Zn.

### Production

The temperature sensitive coatings are typically formed by first manufacturing a precursor powder of the desired composition, then feeding it into a thermal spray process that heats and projects the powder onto the desired substrate surface. This section describes these steps in further detail.

### Precursor Powder

The requirements, and hence production route, for the precursor powder depend on the thermal spray process used to deposit the coating.

In a preferred embodiment, the deposition is conducted by atmospheric plasma spray, therefore, the powder must be flowable.

In a preferred embodiment, the particle size is between 10-80 µm. Smaller particle sizes may be used for alternative thermal spray processes. Larger particle sizes may be used although this is expected to result in thicker coatings which may be undesirable.

In principle, any suitable production route can be used to manufacture the precursor powder provided it can achieve the desired particle size distribution. In one embodiment, the powder is produced by an agglomeration and sintering process. In another embodiment, the powder is produced by a co-precipitation method.

The mechanism covered by this invention is also observed in powder samples without production into coatings. In other words, the temperature sensitive material works for coating and powder alike. In this case, the final heat treatment temperature of the production process is approximately the minimum temperature of the temperature sensitivity of the material. In the preferred embodiment, the powder may be produced for this purpose by a sol-gel route. The particle size in this embodiment may be 10 nm to 50 µm, but the preferred distribution is 10 to 30 µm. The resultant powder can be used as a temperature sensitive material in powder form (as shown previously in FIG. 6), whereby it is mixed into a liquid binder and applied as a paint. Alternatively, the powder can be pressed into pellets and embedded into the object of interest or attached to the surface by an adhesive.

### Surface Preparation

The temperature sensitive coatings may be applied to different substrate materials, which will affect the surface preparation required.

To apply the coating to a metallic surface, typically a bond coat is applied first to improve the adhesion of the coating by increasing the mechanical interlocking and mediating the difference in thermal expansion coefficient of the metal substrate and ceramic coating. In this case, the metallic surface is grit blasted to achieve a surface roughness of 2 µm to 10 µm Ra and preferred 5 µm Ra. The bond coat material is MCrAlY where M is Ni, Co or Fe or a combination of those. It is applied by thermal spray, usually atmospheric plasma spray or high velocity oxy-fuel spray. The thickness of the bond coat is preferably 30-80 µm. The temperature sensitive coating is applied to the surface of the bond coat.

The coating can be applied directly to an existing ceramic coating, such as thermal barrier coatings that are typically found on hot section components of gas turbine engines. In this case, minimal surface preparation is required to avoid potentially damaging or contaminating the existing ceramic coating. The existing ceramic coating may be cleaned using a solvent (e.g. acetone) then heat treated to remove residual solvent. The temperature sensitive coating is applied directly onto the existing ceramic coating.

The coating can also be applied to a solid ceramic substrate (e.g. sapphire). In this case, the surface of the ceramic substrate is grit blasted to achieve a surface roughness of approximately 2 µm to 10 µm Ra and preferred 5 µm Ra. The temperature sensitive coating is applied to the surface of the ceramic substrate. Alternatively, the coating can be applied to ceramic composite materials (e.g. Silicon carbide) in which case a suitable bond coat and/or existing ceramic coating may be present at the surface. The temperature sensitive coating is applied to the surface of the bond coat or existing ceramic coating.

### Coating Deposition

In the preferred embodiment, the temperature sensitive coating is applied by atmospheric plasma spray, a widely used industrial coating process. There are many different commercially available spray equipment systems, and in principle the coating could be produced with any of these systems. The temperature sensitive coatings have been successfully produced using 3MB plasma torch by Oerlikon Metco, F6 plasma torch by GTV and TriplexPro 210 by Oerlikon Metco. Other possible guns include: 9MB, F4MB-XL 3MBTD, SM-F210, SM-F300, iPro-90 from Oerlikon Metco.

The coating may be applied by other possible routes for example chemical vapour deposition, electron-beam physical vapour deposition, suspension plasma spray or solution precursor plasma spray.

The settings of the spray system used to apply the coatings influence the deposited coating material and its performance as a temperature sensitive coating. The settings alter the lifetime decay of the coating in the as-deposited state (FIG. 12). The settings also influence how the lifetime decay of the coating changes at high temperature, above the crystallisation temperature (FIG. 13). As such it is possible to select the settings to optimise the performance of the temperature sensitive coating. The optimum settings are expected to vary with different spray equipment, however, testing to date have indicated the following preferred settings:

| | |
|---|---|
| • Power: | 20-50 kW |
| • Stand-off distance: | 100-140 mm |
| • Scan rate: | 500-750 mm/s |

More settings are influential, but these will be more dependent on the spray equipment used.

In the preferred embodiment, the thickness of the temperature sensitive coating is 20-50 µm. While a thinner coating would be desirable, it would be difficult to produce with the process described here. A thicker coating would be easier to produce, however, would impart a greater thermal insulation on the surface and would lead to greater thermal gradients between the surface of the coating and the surface of the substrate.

The luminescent properties of the temperature sensitive coating change with temperature. There are different methods to record these changes.

### Lifetime Decay

As mentioned previously, the lifetime decay of the luminescence can be detected by recording the emission from the coating after pulsed excitation. In one embodiment, the lifetime decay is detected using an opto-electronic instrument as illustrated in FIG. 14. A modulated, diode pumped solid state laser emitting at 532 nm is coupled into an optical fibre. The other end of the optical fibre is directed at the coating. The laser excites the luminescence in the coating, so it emits at a different wavelength to the laser. The emitted light is collected by a lens into an optical fibre bundle. The emission light is passed through an interference filter to select the preferred wavelength range and an intensity filter is used to regulate the intensity of the received signal. The filtered light is collected by a detector, for example a silicon photomultiplier. The acquired signal is digitised using an analogue to digital data acquisition card and the digital signal is passed to a computer for processing. The observed lifetime decay signal is fitted to a single exponential decay equation using a commercial least-squares fitting algorithm. The algorithm outputs the lifetime decay value.

As mentioned previously, the lifetime decay can be single- or multi-exponential.

### (I) Instrumentation Alternatives

In another embodiment, the excitation light source may be a laser diode or light emitting diode.

In another embodiment, the excitation light source may be operating at a different wavelength in the range 200-900 nm.

In another embodiment, the detector may be a photomultiplier tube, photodiode or camera.

In another embodiment, either one or both filters may be excluded from the system.

In another embodiment, the optical fibres may be a bundle of multiple fibres or a single fibre, or the optical fibres may be excluded.

### (II) Emission Filters

The lifetime decay observed depends on the observed wavelengths of the emission, therefore, the interference filter has an effect on the results from the coating (FIG. 16). In the example shown in FIG. 16, the preferred emission filter is 661 ±20 nm because it shows the greatest dynamic range in lifetime decay over the widest range. Other emission filters are preferable for other materials.

In one embodiment, multiple interference filters can be used to record simultaneously or sequentially to acquire different data sets that can be used to relate the measured lifetime decay to temperature.

### (III) Fitting Window

Different periods of the observed lifetime decay signal may be used to apply the fitting algorithm to deliver different results. As such, multiple calibration data sets can be generated for the same material by adjusting the period of signal used for the fitting algorithm (FIG. 17).

The chosen period of the signal for fitting may be selected to achieve the optimum results for a given application.

### (IV) Indirect Luminescence Properties

Indirect features of the luminescence properties can also be used to generate a calibration data set, for example, the mean square error of the fit function to the measured signal (see FIG. 18). These features can be used solely or in conjunction with the primary luminescence property to generate a calibration data set.

### Sine Wave

In one embodiment, the excitation light source follows a sinusoidal waveform and the luminescence detected is measured as a phase shift from the original waveform due to the delay introduced by the luminescence lifetime decay.

### Spectral Response

As mentioned previously, the lifetime decay of the luminescence can be detected by recording the emission spectrum from the coating after or during excitation. In one embodiment, the emission is detected using an opto-electronic instrument as illustrated in FIG. 19.

A diode pumped solid state laser emitting at 532 nm is coupled into an optical fibre (note: other laser excitation wavelengths are feasible). The other end of the optical fibre is directed at the coating. The laser excites the luminescence in the coating, so it emits at a different wavelength to the laser. The emitted light is collected by a lens into an optical fibre bundle. The emission light is passed through an interference filter to minimise the reflected laser light. The filtered light is passed to a spectrometer, which records the intensity of the light with respect to wavelength. The acquired signal is digitised using an analogue to digital data acquisition card and the digital signal is passed to a computer for processing. The emission spectrum of the material changes with heat treatment temperature, examples are shown in FIG. 20 and FIG. 21. These changes can be measured in different ways, relating to the number, width, shape and wavelength of the peaks.

### (I) Intensity Ratios

In one embodiment, the change in the emission spectrum with temperature is measured by calculating the ratio of the intensity recorded in one wavelength range to the intensity recorded in another wavelength range, an example is shown in FIG. 22. The intensity ratio measurement can be used to generate a calibration data set.

### (II) Peak Width

In one embodiment, the change in the emission spectrum with temperature is measured by a calculating the width of a single peak or multiple peaks, in the spectrum, an example is shown in FIG. 23.

### Combined Parameter Measurement

A combination of the measurement parameters described in the previous sections can be used to analyse the temperature sensitive coating and, therefore, acquire temperature measurements. As shown previously, different measurement parameters give different responses with temperature, hence, combining these measurement results can provide an improved measurement.

### Multi-Variate Regression Modelling

In one embodiment of the measurement, the calibration data set can be generated by a multi-variate regression model. A combination of measurement parameters acquired from the calibration samples are used to generate the model. The same measurement parameters are measured on the test component and compared to the model to output a measured temperature. This approach accounts for a combination of measurement parameters simultaneously.

The present invention offers a method to record the maximum operating temperature profile of a component in harsh test conditions without requiring access during operation.

In use of the present invention, a temperature sensitive material is applied to the desired component (e.g. turbine blade from aircraft engine) typically in the form of a coating, although may be a powder or paint. The component is operated in the required test environment (e.g. test aircraft engine). During operation the elevated temperature causes the material to permanently change and the extent of the change depends on the maximum temperature of exposure at any given location. The permanent changes to the material alter the luminescence properties of the material. After operation, the luminescence of the material is measured and then, through calibration, this is related to the maximum temperature of operation.

It will be understood that the present invention has been described in its preferred embodiments and can be modified in many different ways without departing from the scope of the invention as defined by the appended claims.

1. A temperature-sensitive material comprising a ceramic oxide host and a luminescent dopant, wherein the material exhibits one or more phase transformations.

2. The material of claim 1, wherein the material has a crystallisation temperature and exhibits the one or more phase transformations at a temperature above the crystallisation temperature.

3. The material of claim 1, wherein the ceramic oxide host includes one or more of Y, AI, Si, Sc, Y, La, Ti, Zr, Hf, V, Nb, Ta, Cr, Mo, Mn, Zn, Cd, Ce, Pr, Nd, Pm, Sm, Gd, Tb, Dy, Ho, Er, Tm, Yb and Lu, optionally including at least two of Y, AI, Si, Sc, Y, La, Ti, Zr, Hf, V, Nb, Ta, Cr, Mo, Mn, Zn, Cd, Ce, Pr, Nd, Pm, Sm, Gd, Tb, Dy, Ho, Er, Tm, Yb and Lu.

4. The material of claim 1, wherein the ceramic oxide host is an yttrium-based oxide, optionally an yttrium-aluminum oxide or an yttrium-silicon oxide, optionally yttrium-aluminum garnet (YAG), yttrium-aluminum perovskite (YAP), yttrium-aluminum monoclinic (YAM), yttrium monosilicate (YMS), yttrium disilicate (YDS) or yttrium silicate (YSO).

5. The material of claim 1, wherein the ceramic oxide host is an aluminum-based oxide.

6. The material of claim 1, wherein the dopant comprises one or more rare earths and/or one or more transition metals.

7. The material of claim 6, wherein the one or more rare earths are selected from Eu, Ce, Pr, Nd, Pm, Sm, Gd, Tb, Dy, Ho, Er, Tm, Yb and Lu, and the one or more transition metals are selected from Ti, V, Cr, Mn, Fe, Co, Ni, Cu and Zn.

8. The material of claim 1, wherein the dopant has a concentration of from 0.01 at% to 3 at%, optionally between 0.4 at% and 0.8 at%, optionally the dopant is Eu.

9. A powder comprising the material of claim 1.

10. A method of fabricating the powder of claim 9, comprising mixing at least two precursor materials and the dopant to provide a mixture, spray drying the mixture to form precursor particles, and agglomerating or sintering the precursor particles to form a ceramic oxide powder.

11. The method of claim 10, comprising an yttrium precursor material, optionally yttrium chloride (YCI) or yttrium oxide (Y₂O₃), and at least one other, different precursor material.

12. The method of claim 11, wherein the yttrium precursor material and aluminum oxide (Al₂O₃) are mixed in a ratio of from 1:2 to 3:1, optionally from 1:1 to 2:1, optionally from 5:3 or 2:1.

13. The method of claim 11, wherein the yttrium precursor material and silicon oxide (SiO₂) are combined in a ratio of from 2:3 to 1:9, optionally from 1:1 to 1:3.

14. The method of claim 10, wherein the ceramic oxide powder has a mean particle size of between 10 µm and 80 µm, optionally from 10 µm to 50 µm, optionally from 10 µm to 30 µm, optionally between 20 µm and 80 µm, optionally from 20 µm to 50 µm, optionally from 20 µm to 30 µm.

15. The method of claim 10, wherein the ceramic oxide powder has a particle size distribution of d₁₀ of from 8 µm to 12 µm, optionally 10 µm, d₅₀ of from 30 µm to 40 µm and d₉₀ of from 90 µm to 100 µm, optionally 95 µm.

16. A coating comprising the material of claim 1 applied to a substrate, optionally as a paint or a solid coating.

17. The coating of claim 16, wherein the coating has a thickness of from 10 µm to 50 µm, optionally from 20 µm to 50 µm.

18. A method of applying the coating of claim 16, comprising thermally spraying a powder comprising the material onto the substrate, optionally by plasma spray coating, atmospheric or air plasma spray coating, suspension plasma spray coating, solution precursor plasma spray coating, oxy-fuel spray coating or high-velocity oxy-fuel spray coating.

19. The method of claim 18, wherein the powder has a mean particle size of between 10 µm and 80 µm, optionally from 10 µm to 50 µm, optionally from 10 µm to 30 µm, optionally between 20 µm and 80 µm, optionally from 20 µm to 50 µm, optionally from 20 µm to 30 µm.

20. The method of claim 18, wherein the powder is spherical.

21. The method of claim 18, wherein the powder has a flowability, measured by the Hall method, of from 3.5 to 5.5 seconds per gram, optionally from 4 to 5 seconds per gram.

22. The method of claim 18, wherein the coating is applied at a power of from 10 kW to 60 kW, optionally from 10 to 20 kW, optionally for yttrium aluminum garnet (YAG), optionally from 40 kW to 60 kW, optionally for yttrium silicate (YSO).

23. The method of claim 18, wherein the coating is applied at a stand-off distance of from 80 mm to 150 mm from the substrate.

24. The method of claim 18, wherein the coating is applied at a scan rate of from 350 mm/s to 750 mm/s.

25. The method of claim 18, wherein the coating is applied in a gas flow containing at least argon and hydrogen, optionally argon is supplied at a flow rate of from 24 litres per minute to 44 litres per minute, optionally hydrogen is supplied at a flow rate of from 5 to 20 litres per minute.

26. A method of determining a thermal history of the material of claim 1, the method comprising:
(I) obtaining at least one first measurement of luminescence as a function of time from the material;
(II) obtaining at least one second measurement of luminescence as a function of wavelength from the material; and
(III) determining a temperature to which the material has been subjected by referencing the at least one first measurement and at least one second measurement to calibration data for the material.

27. The method of claim 26, wherein the at least one first measurement is of lifetime decay of the material following pulsed excitation, optionally the lifetime decay is single-exponential or multi-exponential.

28. The method of claim 27, wherein the at least one first measurement is one or more of (i) signal amplitude of the lifetime decay, (iii) a fitting parameter of the lifetime decay, optionally mean squared error, and (iii) signal reflection of the lifetime decay, optionally at one or more wavelength positions.

29. The method of claim 26, wherein the at least one second measurement is of an emission spectrum of the material.

30. The method of claim 29, wherein the at least one second measurement is one or more of (i) integrated intensity of an emission peak, (ii) integrated intensity between two emission peaks, (iii) a width of an emission peak, (iv) a height of a peak, and (v) a position of a peak.

31. The method of claim 26, wherein the temperature is greater than 1200° C., optionally greater than 1300° C., optionally in the range of from 1200° C. to 1700° C.
